(19) United States
(12) Patent Application Publication
(10) Pub. No.: US 2008/0111094 A1
(43) Pub. Date: May 15, 2008

(54) Air compressed sluice valve

(75) Inventor: Wen-Chin Shu, Taipei (TW)

Correspondence Address: WEN-CHIN SHU, 20525 Via Talavera, Yorba Linda, CA, 92887, US

(73) Assignee: WORLD FRIENDSHIP CO., LTD.

(21) Appl. No.: 11/595,725

(22) Filed: Nov. 13, 2006

(51) Int. Cl. F16K 3/00

(52) U.S. Cl. 251/326

(57) ABSTRACT

The present invention provides an improved structure of an air compressed valve comprising a sluice pipe and a sluice outlet, wherein the sluice pipe has an external screw pattern and a blockade located at one end opening. At least one water entrance is provided at one side of the blockade, and the water entrance is connected to a water passage located inside the sluice pipe so that water can exist from another end opening of the blockade. The sluice outlet comprises a screw head and a screw pipe extended from one end opening of the screw head, wherein the screw pipe further comprises an external screw pattern and an internal screw pattern connected to an internal side of the screw head. The sluice pipe to rotate up and down inside the screw head and the screw pipe, and the blockade of the sluice pipe is water-sealed an opening of the screw pipe.

### BACKGROUND OF THE INVENTION

1. Field of Invention

The present invention relates an improved air compressed sluice valve, particularly, the present invention relates an improved air compressed outlet valve that can increase the sluicing speed of the waste water within an air compressor.

2. Description of the Related Art

The air compressed sluice valve is normally utilized as a tool for draining waste water inside the air compressor. The air compressor cumulates water vapour after being used for a period of time, the water vapour would condense inside the air compressor, wherein the water vapour normally condenses and cumulates at the bottom portion of the air compressor resulting malfunction of the device. The water/waste water must be released through a sluice valve from the air compressor such that the device can function normally.

FIGS. 1-3 show respectively a 3-D view of a conventional air compressed sluice valve, a cross-sectional view of the conventional air compressed sluice valve in a closed state and a cross-sectional view of the conventional air compressed sluice valve in an opening state. Refer to FIGS. 1-3, the conventional air compressed sluice valve 1 comprises a sluice pipe 11 and a sluice outlet 12, wherein a sluice hole 121 is provided at a surface area of the sluice outlet 12 to drain out the waste water from the air compressor. A pipe passage 123 of an internal screw pattern 124 is located internally of the sluice outlet 12 as shown in FIGS. 2 and 3 to connect to the sluice pipe 11. An external screw pattern 122 is provided at an outer portion of the sluice outlet 12 and is utilized for connecting to the air compressor. The sluice pipe 11 is a hollow pipe wherein a channel 111 is provided internally, a opening 112 is located above the sluice pipe 11 so that the waste water flows from the sluice hole 121 of the sluice outlet 12 can passing through the opening 112 into the sluice pipe 11. The waste water will then flow through the channel 111 of the sluice pipe 11 and exits from the bottom part of the sluice pipe 11. The internal screw pattern 124 of the sluice outlet 12 is integrated with another external screw pattern 113 of the sluice pipe 11 so that the sluice pipe 11 can be rotated up and down along the internal part of the sluice outlet 12 as shown in FIGS. 2 and 3. When the sluice pipe 11 is rotated upwards, the surface area of a top portion 114 of the sluice pipe 11 will be tightly in contact with the sluice hole 121 of the sluice outlet 12 as shown in FIG. 2 so that the waste water will not drain out. When the sluice pipe 11 is rotated downwards, a gap will be provided in between the sluice pipe 11 and the sluice outlet 12 so that the waste water can flow into the sluice pipe 11 passing through the opening 112 of the sluice pipe into the channel 111, and exit from a bottom part of the sluice pipe 11 as shown in FIG. 3.

The opening of the conventional air compressed sluice valve is designed too small and only one water entrance can result time consuming to build up the air pressure within the air compressor in order to release the waste water therein. Therefore, the it is an objective of the present invention to provide an improved air compressed sluice valve that can overcome the disadvantages and problems of the conventional air compressed sluice valve.

### SUMMARY OF THE INVENTION

It is an object of the present invention to provide an improved structure of an air compressed sluice valve, comprising a sluice pipe and a sluice outlet, wherein the sluice pipe has an external screw pattern and a blockade located at one end opening. At least one water entrance is provided at one side of the blockade, and the water entrance is connected to a water passage located inside the sluice pipe so that water can exist from another end opening of the blockade. The sluice outlet comprises a screw head and a screw pipe extended from one end opening of the screw head, wherein the screw pipe further comprises an external screw pattern and an internal screw pattern connected to an internal side of the screw head. The internal screw pattern can allow the sluice pipe to rotate up and down inside the screw head and the screw pipe, and the blockade of the sluice pipe is water-sealed an opening of the screw pipe. The external screw pattern is corresponding to a set of an air compressor. A slot is provided at one side of the blockade, and a water-proof O-ring is provided inside the slot. An anti-slippery lumpy surface is further provided at a side area of an outlet of the sluice pipe. A water entrance is provided respectively at both corresponding sides of the blockade.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a 3-D view of a conventional air compressed sluice valve;

FIG. 2 is a cross-sectional view of the conventional air compressed sluice valve in a closed state;

FIG. 3 is another cross-sectional view of the conventional air compressed sluice valve in an opening state;

FIG. 4 is a 3-D view of an improved air compressed sluice valve in accordance with a preferred example of the present invention;

FIG. 5 is a cross-sectional view of the improved air compressed sluice valve in a close state in accordance with the preferred example of the present invention;

FIG. 6 is a cross-sectional view of the improved air compressed sluice valve in an opening state accordance with the preferred example of the present invention;

FIG. 7 is a schematic view of an improved air compressed sluice valve in accordance with another preferred example of the present invention.

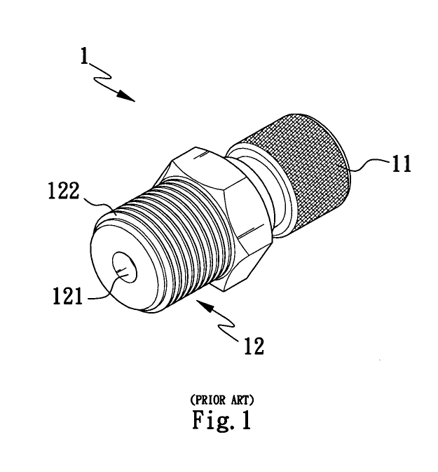

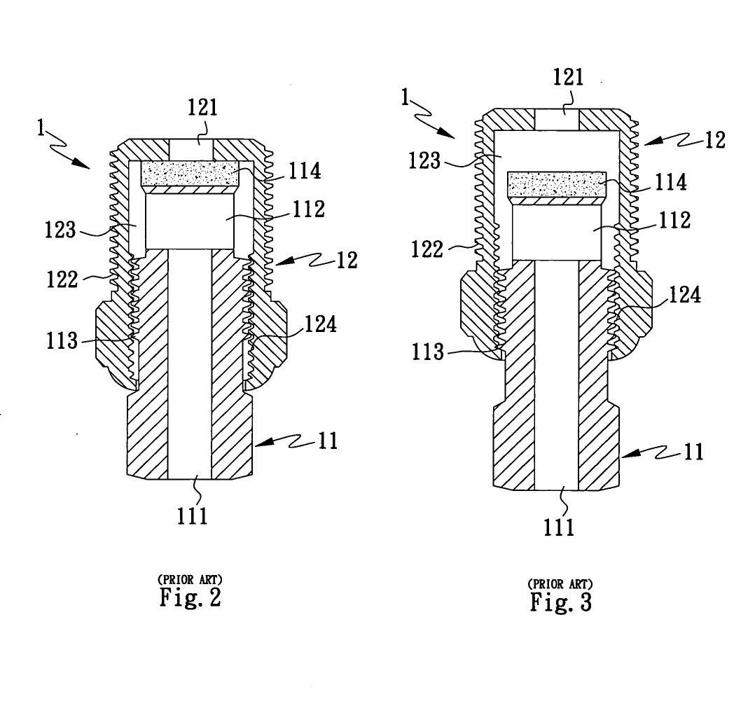

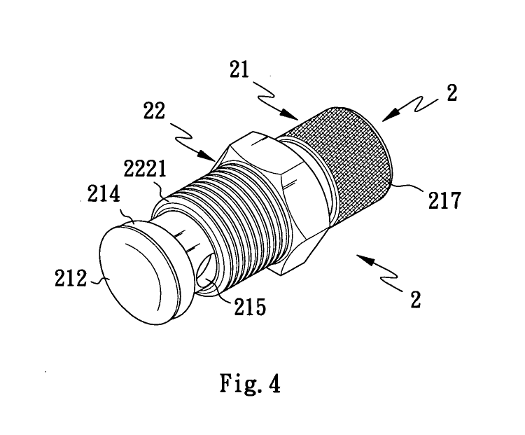

### DESCRIPTION OF THE PREFERRED EMBODIMENTS

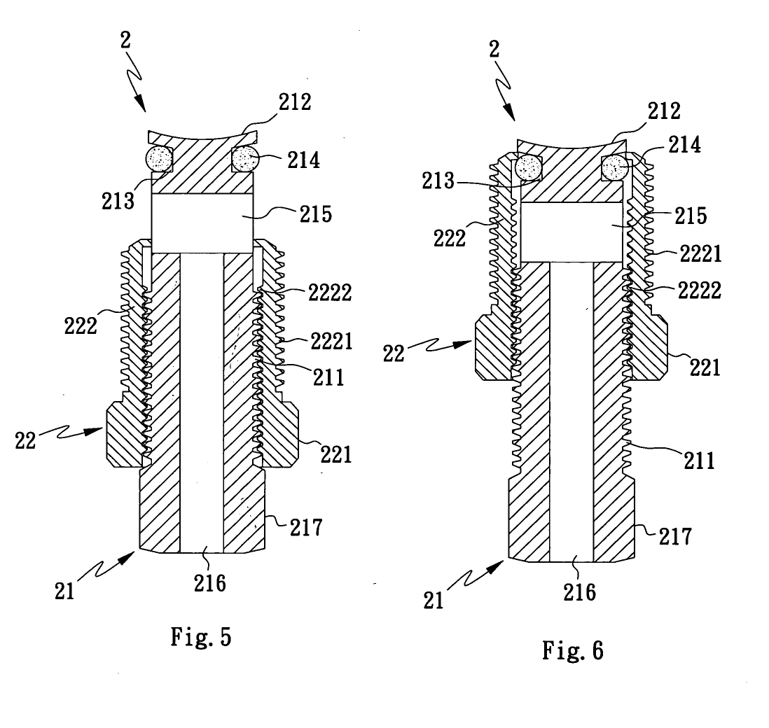

FIG. 4 is a 3-D view of an improved air compressed sluice valve in accordance with a preferred example of the present invention. FIG. 5 illustrates a cross-sectional view of the improved air compressed sluice valve in a close state according to the preferred example of the present invention, FIG. 6 shows a cross-sectional view of the improved air compressed sluice valve in an opening state according to the preferred example of the present invention.

Refer to FIGS. 4-6, an air compressed sluice valve 2 of the present invention comprises a sluice pipe 21 and a sluice outlet 22, wherein a gear-teeth pattern 211 is formed around an external surface of the sluice pipe 21, and a blockade 212 is provided at one end of the sluice pipe 21. One side surface of the blockade 212 is formed into an arc-shaped channel as shown in FIGS. 5 and 6. A slot 213 is provided at each side of the blockade 212, wherein a water-proof O-ring 214 is provided within every slot 213, and a water entrance 215 is provided at one side of the blockade 212 wherein two corresponding sides of the blockade 212 have a water entrance 215 provide respectively thereof. A water passage 216 is connected to the water entrance 215 and an inner part of the sluice pipe 21 to allow water flowing through the water passage to come out form another end of the opening of the blockade 212, and an anti-slippery lumpy surface 217 is provided at the side area of the outlet of the sluice pipe 21.

The sluice outlet 22 comprises a screw head 221 and screw pipe 222 extended from one opening of the screw head 221. The screw pipe 222 further comprises an external screw pattern 2221 and an internal screw pattern 2222 connected to an internal side of the screw head 221, wherein the internal screw pattern 2222 is designed in such that to allow the sluice pipe 21 rotating up and down inside the screw head 221 and the screw pipe 222. The blockade 212 of the sluice pipe 21 can water-seal the opening of the screw pipe 222, and the external screw pattern 2221 is corresponding to a set of an air compressor 3.

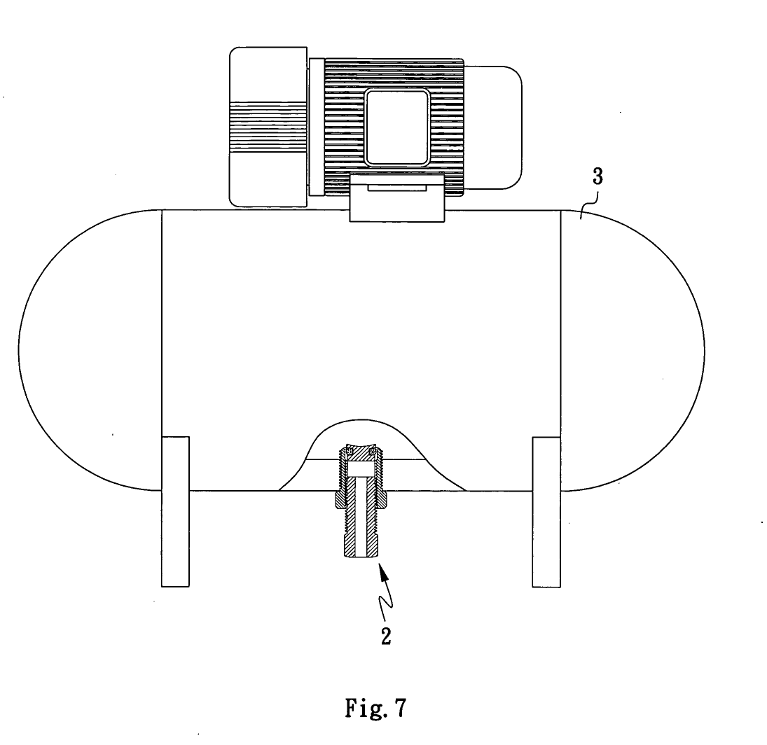

Refer to FIG. 7, a schematic view of an improved air compressed sluice valve in accordance with another preferred example of the present invention, the air compressed sluice valve 2 is located lower area of the air compressor 3. The air compressed sluice valve 2 utilizes its external screw pattern 2221 of the sluice pipe 21 to integrate with the air compressor 3. When a user want to drain the waste water inside the air compressor 3, the anti-slippery lumpy surface 217 of the sluice pipe 21 is rotated to reveal the top portion of the sluice outlet 22 that is the position of the water entrance 215 of the sluice pipe 21 is exposed so that the waste water inside the air compressor 3 can flow from both openings into the water entrance 215 then through the water passage 216 of the sluice pipe 21 to exit from the bottom opening of the passage 216 of the air compressed sluice valve 2 (as shown in FIG. 5).

When the user would like to lock the air compressed sluice valve 2, the sluice pipe 21 is rotated downward such that the water entrance 215 of the sluice pipe 21 is covered up by the sluice outlet 22 as shown in FIG. 6, wherein the waste water cannot entrance through the openings of the water entrance 215. The sluice pipe 21 is rotated downward until its sluice outlet 22 is tighten with the blockade 212 of the sluice pipe 21, and the water-proof O-ring 214 is sealed the gap between the blockade 212 of the sluice pipe 21 and the sluice outlet 22 to prevent waste water from flowing out.

The improved air compressed sluice valve of the present invention provide fast way of draining waste water and it is easy to be operated. The present invention can overcome the default and problems causing by the conventional air compressed sluice valve, such as small opening of the sluice pipe and one water entrance which consumes long period of time to drain the waste water because it takes a long period to build up the air pressure within the air compressor to release the waste water.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An improved structure of an air compressed sluice valve, comprising:
a sluice pipe, having an external screw pattern and a blockade located at one end opening, wherein at least one water entrance is provided at one side of the blockade, and the water entrance is connected to a water passage located inside the sluice pipe so that water can exist from another end opening of the blockade; and
a sluice outlet, having a screw head and a screw pipe extended from one end opening of the screw head, wherein the screw pipe further comprises an external screw pattern and an internal screw pattern connected to an internal side of the screw head, the internal screw pattern can allow the sluice pipe to rotate up and down inside the screw head and the screw pipe, the blockade of the sluice pipe is water-sealed an opening of the screw pipe, and the external screw pattern is corresponding to a set of an air compressor.

2. The improved structure of claim 1, wherein a slot is provided at one side of the blockade, and a water-proof 0-ring is provided inside the slot,

3. The improved structure of claim 1, wherein an anti-slippery lumpy surface is provided at a side area of an outlet of the sluice pipe.

4. The improved structure of claim 1,wherein a water entrance is provided respectively at both corresponding sides of the blockade.
